(19) United States
(12) Patent Application Publication
(10) Pub. No.: US 2018/0196424 A1
(43) Pub. Date: Jul. 12, 2018

(54) MOBILE TERMINAL AND METHOD FOR CONTROLLING THE SAME

(71) Applicant: LG ELECTRONICS INC., Seoul (KR)

(72) Inventors: Duksang KIM, Seoul (KR); Sunho YANG, Seoul (KR); Jaehark PARK, Seoul (KR); Jiho MIN, Seoul (KR)

(21) Appl. No.: 15/744,372

(22) PCT Filed: Nov. 10, 2015
(86) PCT No.: PCT/KR2015/012034

§ 371 Date: Jan. 12, 2018

(30) Foreign Application Priority Data
Jul. 29, 2015 (KR) 10-2015-0107531

(51) Int. Cl. G05D 1/00; G08G 5/00; B64C 39/02

(52) U.S. Cl. CPC G05D 1/0044; G05D 1/0038; B64C 2201/146; B64C 39/024; G08G 5/0017; G08G 5/0069

(57) ABSTRACT

Disclosed are a mobile terminal and a control method thereof. The mobile terminal includes a terminal body; a wireless communication unit configured to communicate with an unmanned aircraft and to receive position information of the unmanned aircraft; a display unit configured to output a captured image received from the unmanned aircraft; and a controller configured to compare an expected distance between the unmanned aircraft and the terminal body using the position information of the unmanned aircraft, wherein the controller controls the display unit to output a map screen including position information of the unmanned aircraft when the expected distance is larger than the reference distance.

### TECHNICAL FIELD

The present invention relates to a mobile terminal capable of controlling an unmanned aircraft.

### BACKGROUND ART

A mobile terminal includes all types of devices provided with a battery and a display unit and carried by a user. The devices are configured to output information to the flexible display unit using power supplied from the battery. The mobile terminal includes a device for recording and playing moving images, a device for displaying a graphic user interface (GUI), etc., which includes a notebook, a mobile phone, glasses, a watch, a game console, etc.

Such a mobile terminal has become increasingly more functional. Examples of such functions include data and voice communications, capturing images and video via a camera, recording audio, playing music files via a speaker system, and displaying images and video on a display. Some portable electronic devices include additional functionality which supports game playing, while other mobile terminals are configured as multimedia players. More recently, mobile terminals have been configured to receive broadcast and multicast signals which permit viewing of content such as videos and television programs.

Recently, various techniques for controlling an operation of an external device which is wirelessly connected to the mobile terminal have been developed. However, there has been a disadvantage in that when the unmanned aircraft, of which flight is remotely controlled, disappears from a user's sight, it is not possible to grasp the position of the unmanned aircraft to be controlled. This may cause a difficulty in controlling the unmanned aircraft.

### DISCLOSURE OF INVENTION

### Technical Problem

It is an object of the present invention to provide a more convenient control method of an unmanned aircraft by providing proper flight information on the unmanned aircraft according to a flight position of the unmanned aircraft.

### Solution to Problem

To achieve these and other advantages and objects of the present invention, there is provided a mobile terminal including: a terminal body; a wireless communication unit configured to wirelessly communicate with a flying unmanned aircraft and receive position information of the unmanned aircraft; a display unit configured to output a captured image received from the unmanned aircraft; and a controller configured to compare an expected distance between the unmanned aircraft and the terminal body with a reference distance using the position information of the unmanned aircraft, wherein the controller is configured to control the display unit to output a map screen including the position information of the unmanned aircraft when the expected distance is larger than the reference distance.

In one embodiment, the display unit may output a thumbnail captured image corresponding to the captured image to one region of the map screen, and the controller may reconvert the map screen into the captured image based on a touch applied to the thumbnail captured image. Thus, since a user can be provided with desired information on the display unit, it is possible to more accurately grasp a position of the unmanned aircraft.

In one embodiment, since the display unit is configured to output an indicator and a route image corresponding to a position of the unmanned aircraft based on position information of the unmanned aircraft, a user can accurately grasp the position of the unmanned aircraft though the unmanned aircraft is out of sight.

In one embodiment, since it is possible to convert the captured image into the map screen when an intensity of a detected signal of wireless communication is smaller than an intensity of the reference signal, it is possible to more accurately grasp flight information of the unmanned aircraft by outputting the map screen instead of the captured image when the communication quality is deteriorated.

### Advantageous Effects of Invention

According to an embodiment of the present invention, it is possible for a user to more accurately grasp a position of an unmanned aircraft by providing a map screen which enables grasp of the position of the unmanned aircraft, rather than a captured screen which has been real time captured, based on a distance between the mobile terminal and the unmanned aircraft, when the unmanned aircraft is out of sight. Thus, the user can more accurately control the flight of the unmanned aircraft.

### BRIEF DESCRIPTION OF DRAWINGS

FIG. 1A is a block diagram illustrating a mobile terminal according to the present invention;

FIGS. 1B and 1C are schematic views illustrating an example of a mobile terminal, viewed from different directions according to the present invention;

FIG. 2A is a flowchart illustrating a control method of a mobile terminal according to one embodiment of the present invention;

FIG. 2B is a schematic view illustrating the control method of FIG. 2A;

FIG. 3A is a flowchart illustrating a control method of a mobile terminal according to another embodiment of the present invention;

FIG. 3B is a schematic view illustrating the control method of FIG. 3A;

FIGS. 4A through 4C are schematic views illustrating a control method for controlling a captured image and a map screen according to one embodiment of the present invention;

FIGS. 5A through 5C are schematic views illustrating a control method for controlling a captured image and a map screen according to another embodiment of the present invention;

FIGS. 6A and 6C are schematic views illustrating a control method for controlling an output of a thumbnail captured image according to still another embodiment of the present invention;

FIGS. 7A through 7C are schematic views illustrating a control method for outputting flight information of an unmanned aircraft; and

FIG. 8 is a schematic view illustrating a control method for converting a captured image into a map screen according to still another embodiment of the present invention.

### MODE FOR THE INVENTION

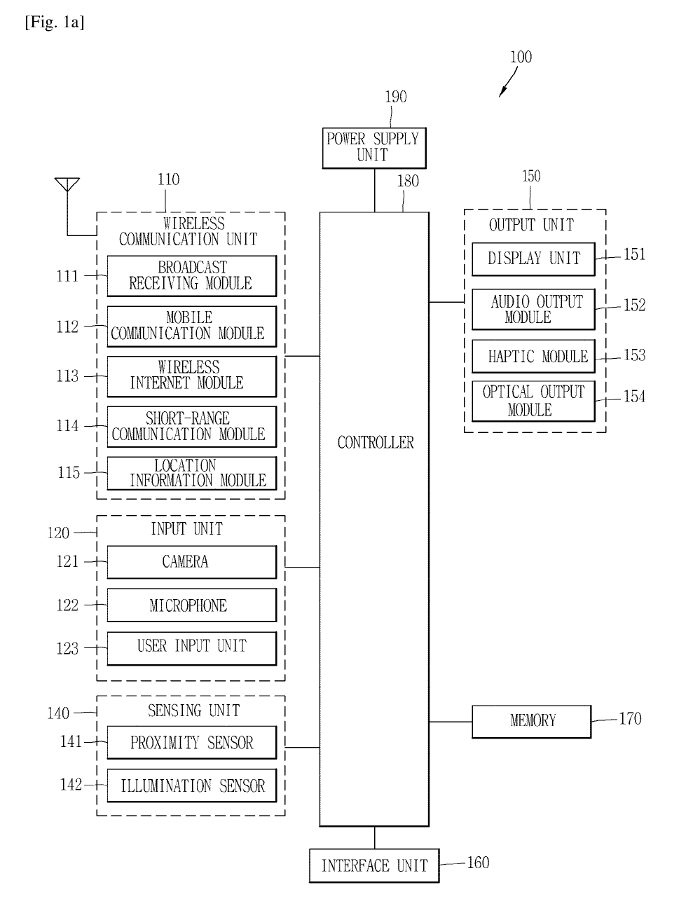

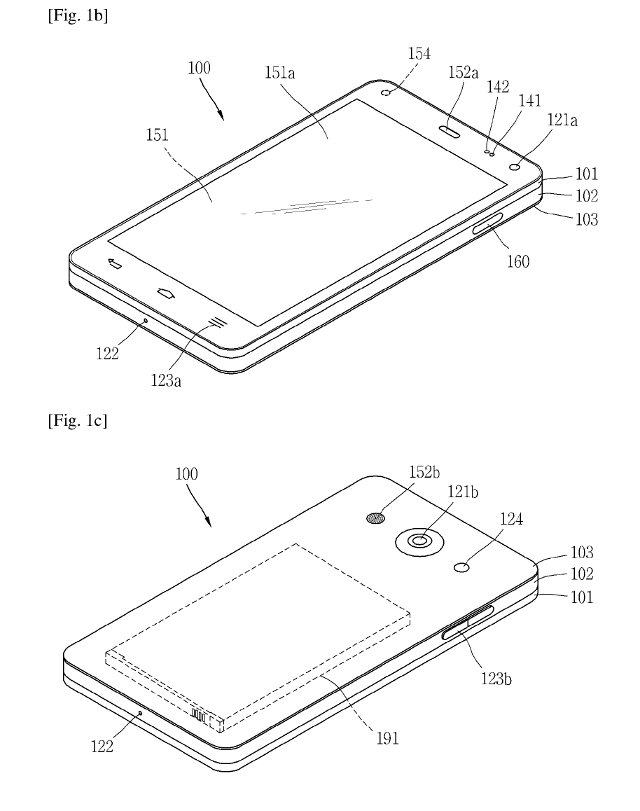

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), EV-DO(Enhanced Voice-Data Optimized or Enhanced Voice-Data Only), Wideband CDMA (WCDMA), High Speed Downlink Packet access (HSDPA), HSUPA(High Speed Uplink Packet Access), Long Term Evolution (LTE) , LTE-A(Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA(High Speed Uplink Packet Access), Long Term Evolution (LTE), LTE-A(Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA,HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB(Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a

Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a unibody is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b.

When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

The mobile terminal according to an embodiment of the present invention may wirelessly communicate with an unmanned aircraft and control functions of the unmanned aircraft. Here, the unmanned aircraft is an aircraft which does not use a runway, and may have a relatively light-weighted and small-sized body loaded with various functions such as transportation of things, capturing of an image and a low altitude reconnaissance search.

The mobile terminal according to an embodiment of the present invention may generate a control command for controlling a flight of an unmanned aircraft and a control command for controlling a camera configured to capture an external environment while flying, among various electronic components mounted to the unmanned aircraft.

Hereinbelow, will be described a control method for controlling various functions of an unmanned aircraft using the mobile terminal.

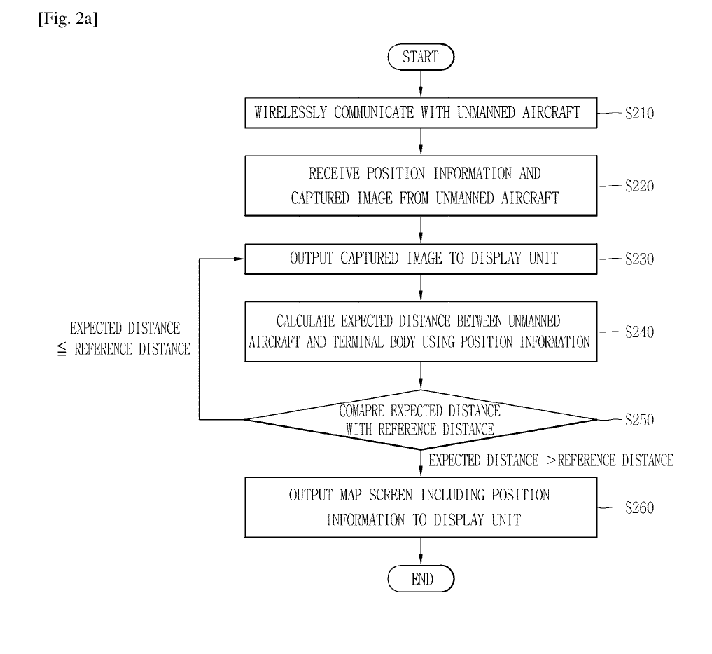

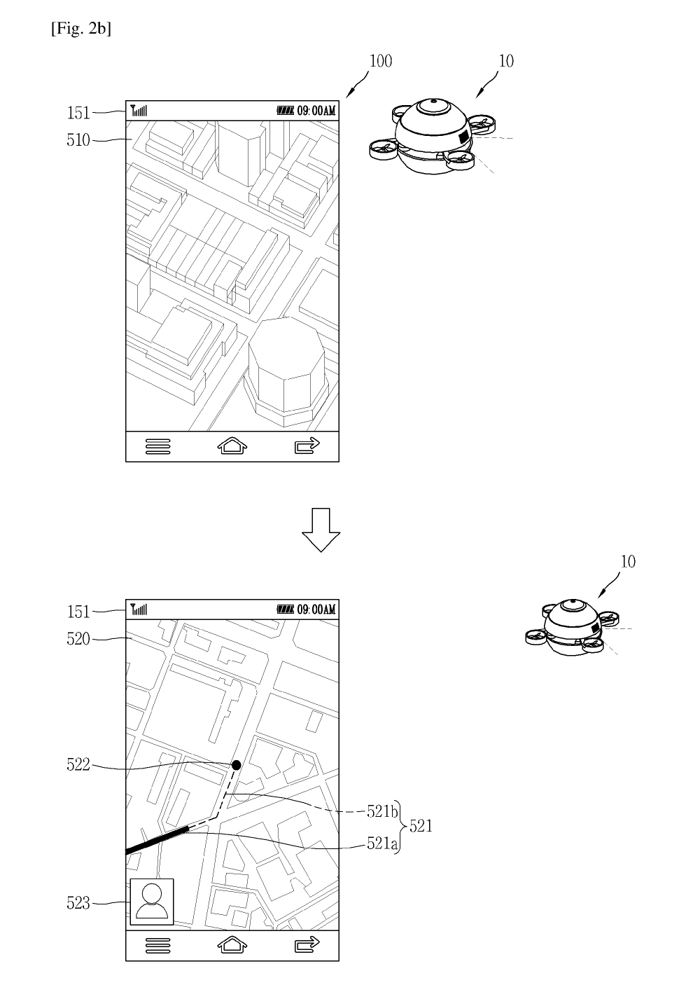

FIG. 2A is a flowchart illustrating a control method of the mobile terminal according to one embodiment of the present invention, and FIG. 2B is a schematic view illustrating the control method of FIG. 2A

The mobile terminal 100 according to an embodiment of the present invention executes wireless communication with the unmanned aircraft 10 (S210). The wireless communication unit 110 transceives (transmits and receives) a wireless signal with the unmanned aircraft 10. The wireless signal may include a control signal for controlling the unmanned aircraft 10 and various information generated by the unmanned aircraft 10. The controller 180 is preinstalled to the mobile terminal 100 and may control the wireless communication unit 110 to execute wireless communication with the unmanned aircraft 10 when an application for controlling the unmanned aircraft 10 is activated.

The wireless communication unit 110 receives position information and a captured image from the unmanned aircraft 10 (S220). The position information may correspond to information related to a current position of the unmanned aircraft 10 which is flying. A type of the position information is not limited and may correspond to a coordinates value, a distance and a direction with respect to a specific reference point (mobile terminal), and a map image. The position information may be received at specific time intervals or real time when it is changed.

The captured image corresponds to an image captured by at least one camera which is mounted to the unmanned aircraft 10. The image which is captured by the camera while the unmanned aircraft is flying may be received real time by the mobile terminal 100. The unmanned aircraft 10 may transmit real time the captured image to the mobile terminal 100, or transmit a captured image which is temporary stored to the mobile terminal 100 at specific time intervals.

The display unit 151 outputs the captured image (S230). The controller 180 may output the captured image 510 real time to an execution screen of an application while the application for controlling the unmanned aircraft 10 is activated. Thus, a user can sense an external environment which is captured by the unmanned aircraft 10 during its flight while recognizing a flight position of the unmanned aircraft 10.

The controller 180 calculates an expected distance between the unmanned aircraft 10 and the terminal body using the position information while the unmanned aircraft 10 is flying (S240). The controller 180 compares the expected distance with a preset reference distance (S250). Here, the reference distance may be set by a user. For instance, a user holding the mobile terminal 100 may set, as the reference distance, a distance where the unmanned aircraft 10 is not visible with the naked eye. Otherwise, the reference distance may be set based on the position information. For instance, when a flight position of the unmanned aircraft 10 corresponds to a landform where there are many high buildings, a landform where there are many high buildings, a landform where there are many tall trees, or a landform where there are a relatively small number of obstacles based on the position information, the reference distance may be set based on information related thereto.

Alternatively, the controller 180 may set real time the reference distance, based on a control command applied by a user while the unmanned aircraft 10 is flying. A user of the mobile terminal 100 may set a distance between the unmanned aircraft 10 and the terminal body as the reference distance when the unmanned aircraft 10 is not identified by the naked eye.

The controller 180 continuously outputs the captured image 510 to the display unit 151 when the expected distance is smaller than or the same as the reference distance (S230). However, when the expected distance is larger than the reference distance, the controller 180 outputs a map screen 520 including the position information (S260).

The map screen 520 may include position information having a current flight position of the unmanned aircraft 10. Thus, the map screen 520 is displayed on a map image on a specific region and may include a first indicator 522 corresponding to the unmanned aircraft 10.

Further, the display unit 151 may display a route image 521 of the unmanned aircraft 10 on the map screen 520. The route image 520 may include first and second regions 521a and 521b which are displayed in different formes. For instance, the first region 521a corresponds to a flight route in a state that the captured image 510 is outputted to the display unit 151, and to a state that the expected distance is smaller than the reference distance. The controller 180 changes a type of the flight route from when the expected distance becomes larger than the reference distance. That is, the second region 521b corresponds to a state that the map screen 520 is displayed, that is, a state that the expected distance is larger than the reference distance. As a result, a user can grasp even a flight route where a distance between the mobile terminal 100 and the unmanned aircraft 10 becomes more than the reference distance, that is, a state that the user can not recognize with the naked eye the unmanned aircraft 10.

Meanwhile, though not shown, when the unmanned aircraft 10 flies based on preset route data, a flight route based on the route data may be displayed on the map screen 520. In this instance, the controller 180 may calculate an expected distance based on the route data, and display the calculated expected distance on the first region 521a or the second region 521b.

Further, the controller 180 may display a second indicator 523 corresponding to a user's position on the map screen 520. As a result, a user can more accurately grasp a position of the unmanned aircraft and his or her position on the map screen.

According to the embodiment of the present invention, it is possible to more accurately grasp a position of the unmanned aircraft, based on a distance between the mobile terminal and the unmanned aircraft, by providing a map screen which enables grasp of the position of the unmanned aircraft instead of a captured image which is real time captured, when the unmanned aircraft is not visible by the user's naked eye. As a result, a user can more accurately control a flight of the unmanned aircraft.

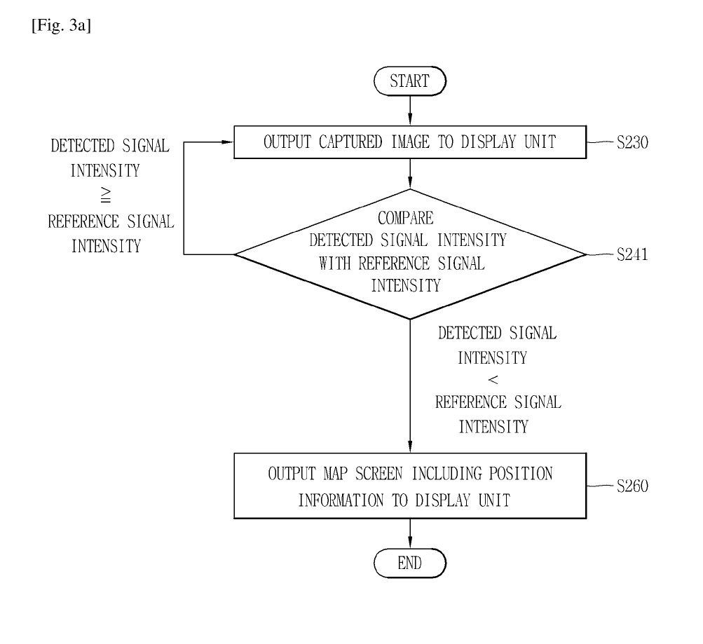

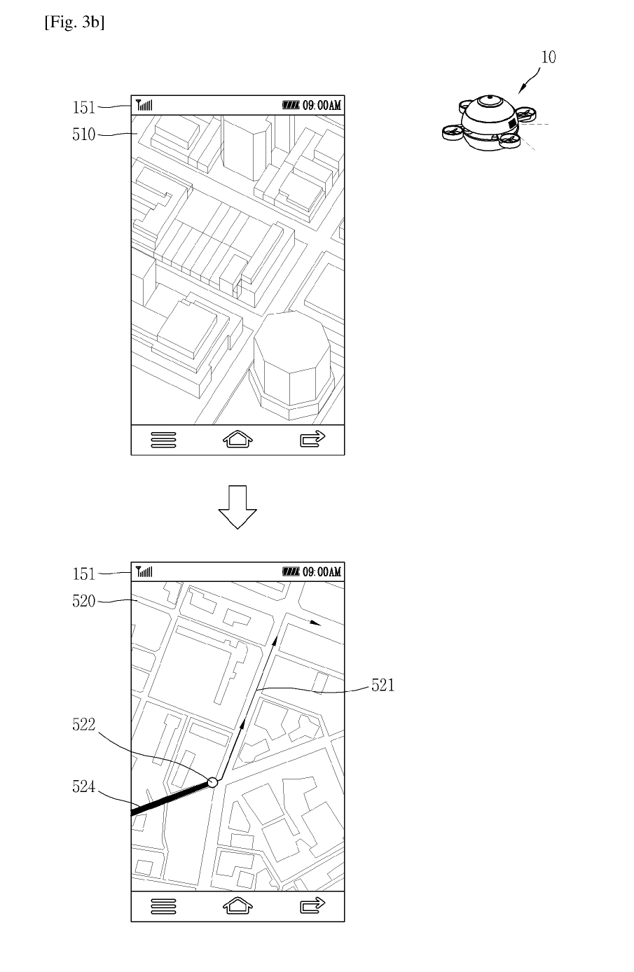

FIG. 3A is a flowchart illustrating a control method of a mobile terminal according to another embodiment of the present invention, and FIG. 3B is a schematic view illustrating the control method of FIG. 3A.

Referring to FIGS. 3A and 3B, the controller 180 controls the wireless communication unit 110 to execute wireless communication with the unmanned aircraft 10, and controls the display unit 151 to output the captured image 510 which is received from the wireless communication unit 110. The wireless communication unit 110 transceives a wireless signal while the unmanned aircraft 10 is flying. The wireless signal may include not only position information and captured image information of the unmanned aircraft 10, and information related to driving of the unmanned aircraft 10, but also an identification signal.

The controller 180 according to an embodiment of the present invention detects an intensity of wireless communication with the unmanned aircraft and compares the intensity of the detected signal with that of a reference signal (S241). The intensity of the detected signal is formed as an intensity of the signal which is received from the unmanned aircraft 10 is detected. The intensity of the signal may be determined by the identification signal, and the identification signal may be transmitted at preset time intervals. When the captured image is set to be real time transmitted, the captured image may be set as the identification signal.

The controller 180 outputs a received captured image to the display unit 151 when the intensity of the reference signal is smaller than or the same as that of the detected signal.

However, when the intensity of the reference signal is larger than that of the detected signal, the controller 180 controls the display unit 151 to output the map screen 520 including the position information. The map screen 520 may include a route image 521 indicating a flight route of the unmanned aircraft 10 and a first indicator 522 corresponding to a position of the unmanned aircraft 10. Further, the display unit 151 may output a signal intensity image 524 indicating the intensity of the wireless signal to the route image 521. For instance, the signal intensity image 524 is formed along the route image 521 so as to have a width corresponding to a signal intensity with respect to each position.

According to this embodiment of the present invention, when it is determined that the captured image can not be received due to a difficulty in wirelessly communicating with the unmanned aircraft, it is possible to more accurately grasp a position of the unmanned aircraft by outputting a map screen including position information of the unmanned aircraft instead of the captured image. Further, the display unit 151 outputs a signal intensity image corresponding to an intensity of a signal so that a user can grasp the quality of wireless communication.

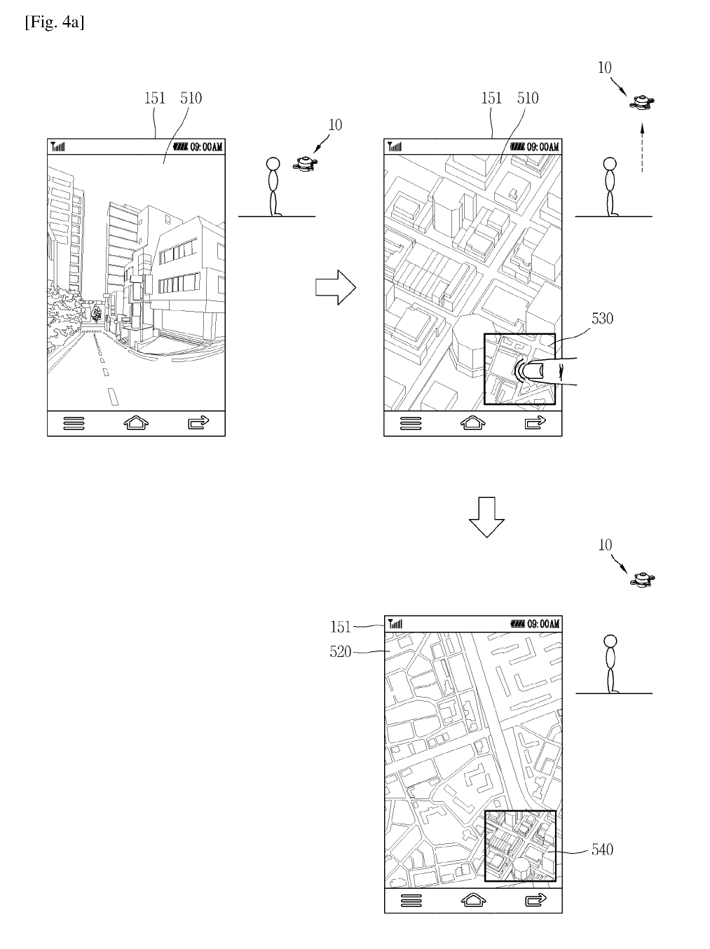

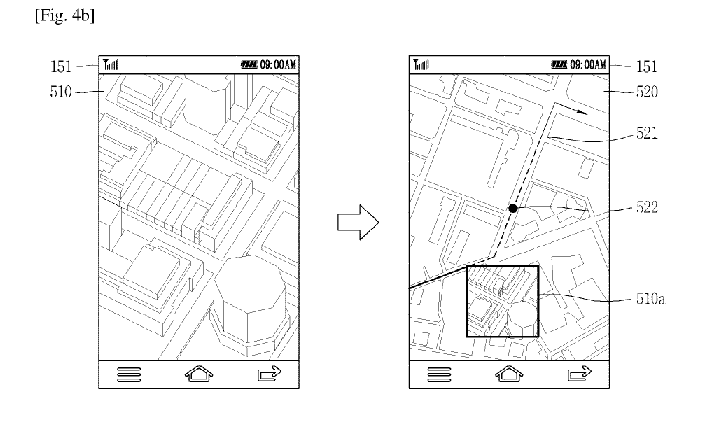

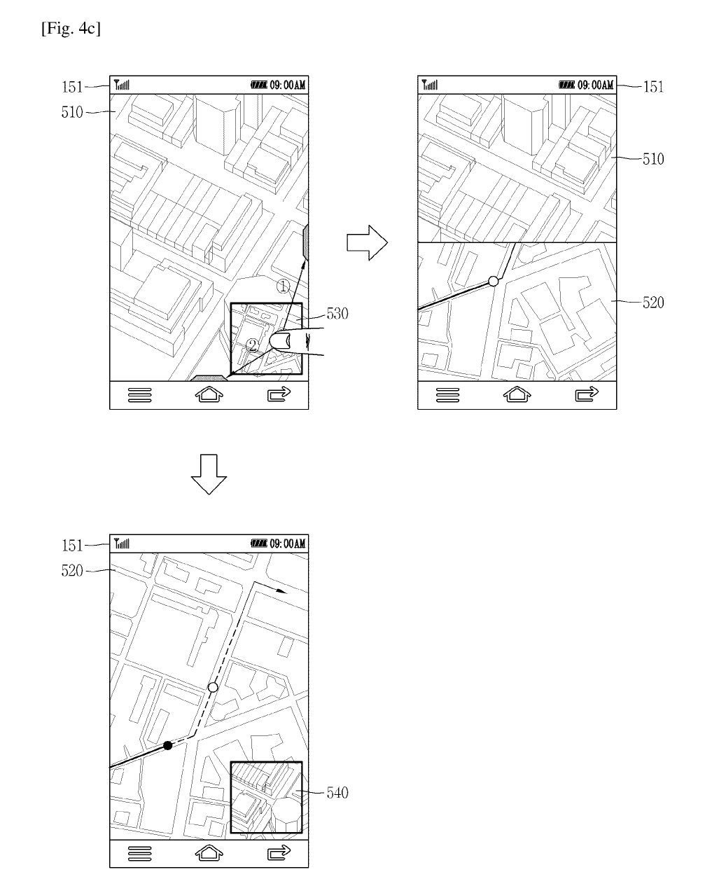

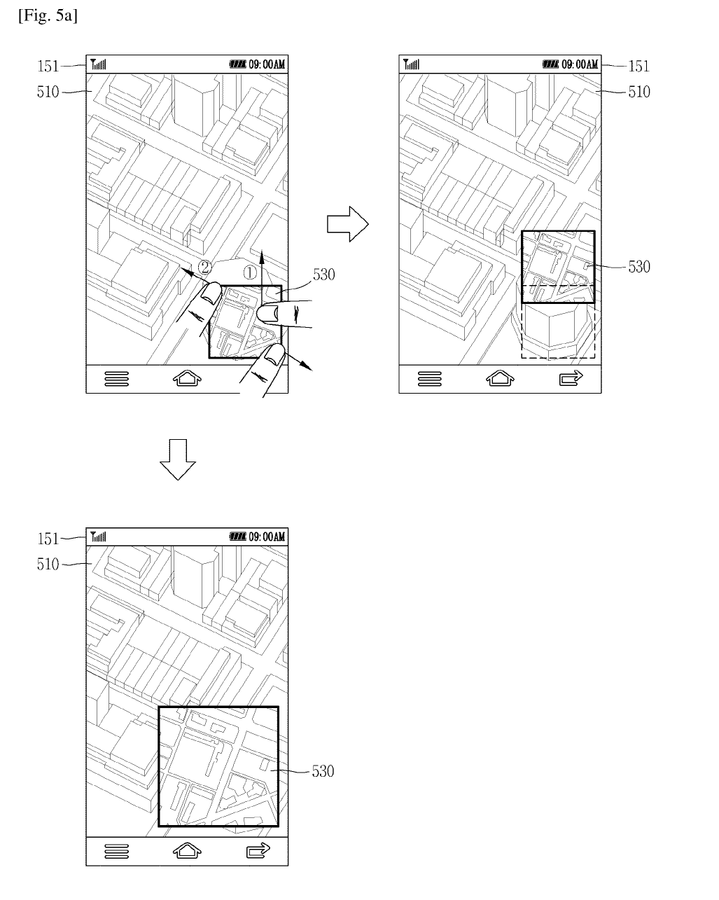

FIGS. 4A through 4C are schematic views illustrating a control method for controlling a captured image and a map screen according to one embodiment of the present invention.

Referring to FIG. 4A, a control method for controlling the mobile terminal based on an altitude of the unmanned aircraft will be described.

The display unit 151 outputs a captured image 510 which is captured by a camera of the unmanned aircraft. The wireless communication unit 110 receives flight information related to the flight of the unmanned aircraft 10 together with the captured image 510. The flight information may include a flight direction, a flight speed, a flight mode and a position mode of the unmanned aircraft 10. The controller 180 may control the display unit 151 using altitude information included in the position information.

The controller 180 controls the display unit 151 to output a map image 530 to one region of the captured image 510 when the altitude of the unmanned aircraft 10 is higher than a preset reference altitude. The map image 530 may include position information of the unmanned aircraft 10.

The controller 180 outputs the map screen 520 instead of the captured image 510 based on an input of a specific type of touch to the map image 530. The map screen 520 may include information substantially the same as that of the map image 530. Further, the display unit 151 outputs the thumbnail captured image 540 to one region of the map screen 520.

The thumbnail captured image 540 is substantially the same as the captured image 510, and may correspond to a thumbnail view having a reduced size of the captured image 510. The thumbnail captured image 540 may be varied real time based on information related to a captured image which is received real time from the unmanned aircraft 10. Though not shown specifically, the controller 180 controls the display unit 151 to output the captured image 510 based on a touch applied to the thumbnail captured image 540.

When it is difficult to grasp a position of the unmanned aircraft 10 since the altitude of the unmanned aircraft 10 becomes higher, not only a captured image, but also map information may be provided. Further, a user can selectively check the captured image or the map screen.

Referring to FIG. 4B, a control method for displaying a thumbnail captured image will be described.

Referring again to FIG. 2B and FIG. 3B, the controller 180 converts the captured image 510 into the map screen 520 when the expected distance is larger than the reference distance or an intensity of the measured signal is smaller than that of the reference signal.

The controller 180 may not output the received captured image while the map screen 520 is outputted, or the wireless communication unit 110 may be in a state that it can not receive the captured image.

The display unit 151 outputs the thumbnail captured image 510a which corresponds to the captured image 510 when the captured image 510 is converted into the map screen 520, to the map screen 520.

The map screen 520 includes a route image 521 indicating a flight route of the unmanned aircraft 10. The route image 521 may include a past flight route of the unmanned aircraft 10, and a future flight route of the unmanned aircraft 10 based on preset route data. The first indicator 522 indicating a current position of the unmanned aircraft 10 is displayed on one region of the route image 521.

The thumbnail captured image 510a is displayed on the route image 521, and the thumbnail captured image 510a corresponding to a position of the unmanned aircraft 10 is displayed on a specific region of the route image 521 when the captured image 510 is converted into the map screen 520.

According to an embodiment of the present invention, a user can check a time point when a distance between the mobile terminal 100 and the unmanned aircraft 10 is more than the reference distance and a time point when the quality of wireless communication becomes deteriorated than a reference value, and also can grasp the external environments at those time points.

Referring to FIG. 4C, a control method for controlling the map screen and the captured image according to another embodiment of the present invention will be described.

The display unit 151 outputs a map image 530 to one region of the captured image 510. The controller 180 outputs the map image 520 and the captured image 510 to one region of the display unit 151 by a touch of a specific type applied to the map image 530.

The specific type of touch is applied to the map image 530 at first, and may correspond to a touch input of a dragging type or a flicking type which is consecutively applied. The map image 530 moves on the display unit 151 so as to correspond to a moving direction of the specific type of touch.

The controller 180 controls the display unit 151 to convert the capture image 510 into the map screen 520 when the touch is released in a state that the map image 530 is adjacent to one edge of the display unit 151. Further, the controller 180 outputs the thumbnail captured image 540 corresponding to the captured image 510 to one region of the map screen 520.

Meanwhile, the controller 180 divides the display unit 151 when the touch is released in a state that the map image 530 is adjacent to another edge of the display unit 151. The controller 180 outputs the captured image 510 to one region of the display unit 151, and outputs the map screen 520 to another region of the display unit 151.

Though not shown specifically, the display unit 151 may control a transparency of the captured image 510 and the map screen 520 based on the specific type of touch and output the captured image 510 and the map screen 520 in an overlapping manner.

According to an embodiment of the present invention, a user can output the captured image and the map screen together. Thus, a user can be provided with desired information on the display unit 151 with a desired size while the unmanned aircraft flies.

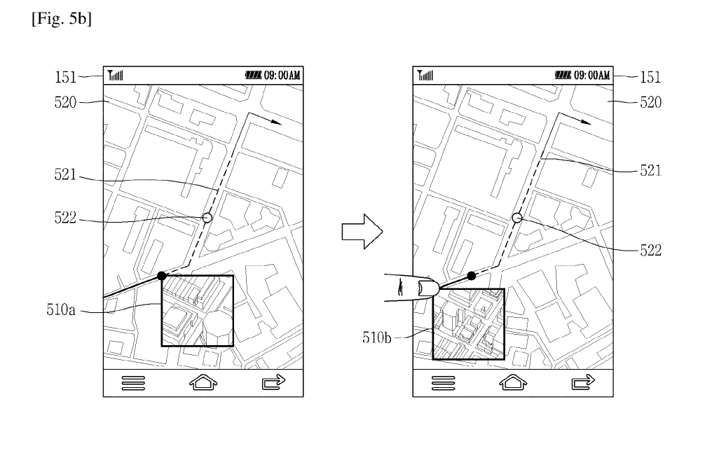

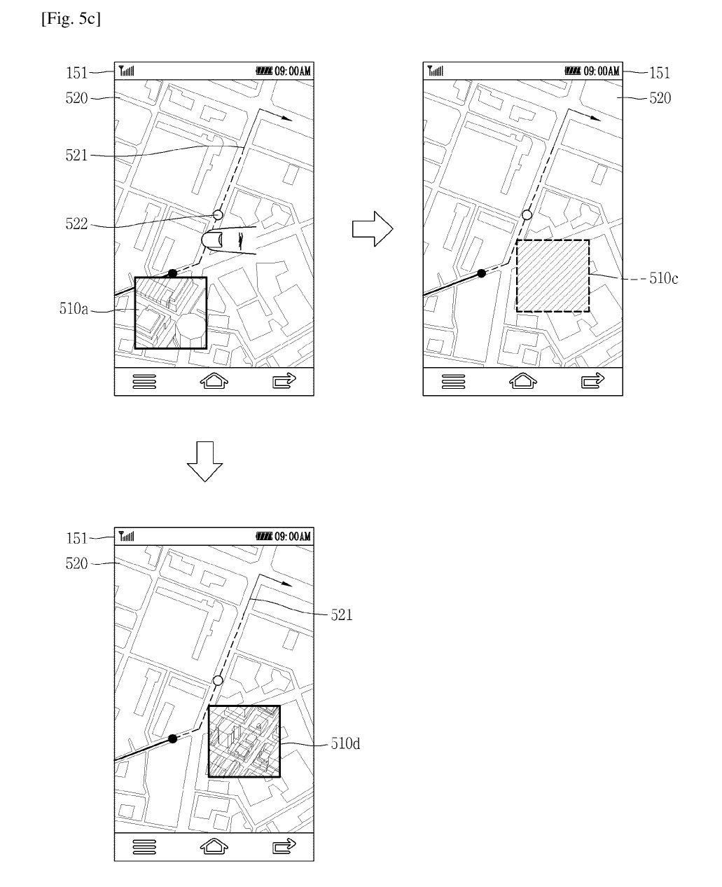

FIGS. 5A through 5C are schematic views illustrating a control method for controlling a captured image and a map screen according to another embodiment of the present invention.

Referring to FIG. 5A, the map image 530 is outputted to the captured image 510. The controller 180 controls the display unit 151 to change a position of the map image 530 based on a touch input 1 applied to the map image 530.

Meanwhile, the controller 180 controls the display unit 151 to change a size of the map image 530 based on a touch input 2 of another type which is applied to the map image 530.

Referring to FIG. 5B, the display unit 151 outputs a map screen 520 including a route image 521, and a first indicator 522 indicating a position of the unmanned aircraft 10.

The display unit 151 may output a first thumbnail captured image 510a so as to be adjacent to one region of the route image 521. The first thumbnail captured image 510a may be displayed on one region of the route image 521 based on position information when the thumbnail captured image 510a is captured.

The controller 180 may control the display unit 151 to output a thumbnail captured image corresponding to one region of the route image 521 based on a touch applied to the route image 521. Specifically, position information corresponding to a specific region of the route image 521 where a touch is applied is extracted, and a thumbnail captured image which is captured based on the position information is selected to be outputted. An image which is captured at a position corresponding to one region of the route image may be provided. The second thumbnail captured image 510b may be displayed so as to be adjacent to one region where the touch is applied.

The display unit 151 may consecutively change the thumbnail captured image based on a consecutive touch applied to the route image 521. Thus, a user can be provided with a captured image which is captured during a flight.

Referring to FIG. 5C, the display unit 151 may output the map image 520 including the route image 521 and the first indicator 522. The display unit 151 may output the first thumbnail captured image 510a to the route image 521, and position information corresponding to the route image 521 may be output based on a touch applied to the route image 521.

However, when a captured image corresponding to one region of the route image 521 where the touch has been applied is not searched, the controller 180 may output a third thumbnail captured image 510c. The third thumbnail captured image 510c may be indicated as a blank region having no image. Though not shown, position information on a position where the touch is applied may be displayed on the third thumbnail captured image 510c, or visual information indicating the reason why the capturing has not been executed may be displayed on the third capturing image 510c.

Otherwise, when a captured image corresponding to one region of the route image 521 where the touch is applied, is not searched, the controller 180 may receive a thumbnail captured image from a specific server by using the position information. The controller 180 may search an image using the position information and output the image as a fourth thumbnail captured image 510d.

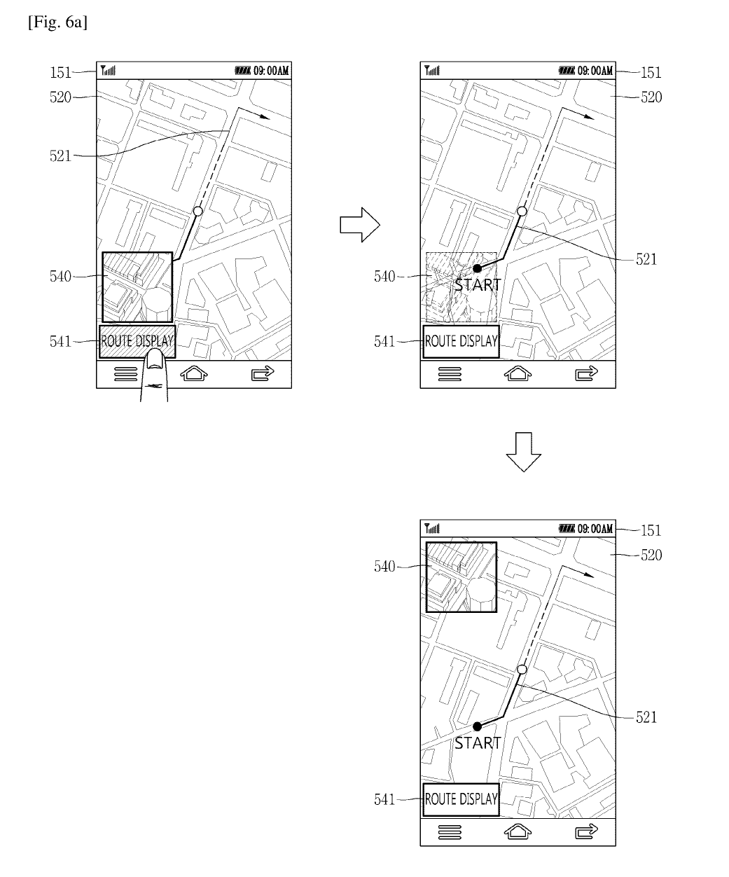

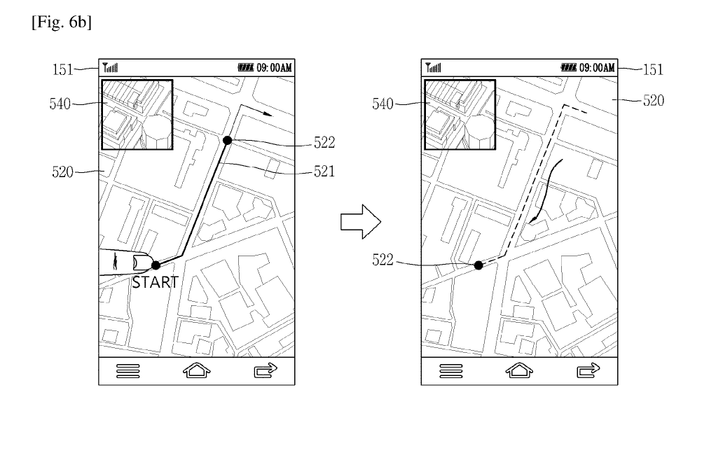

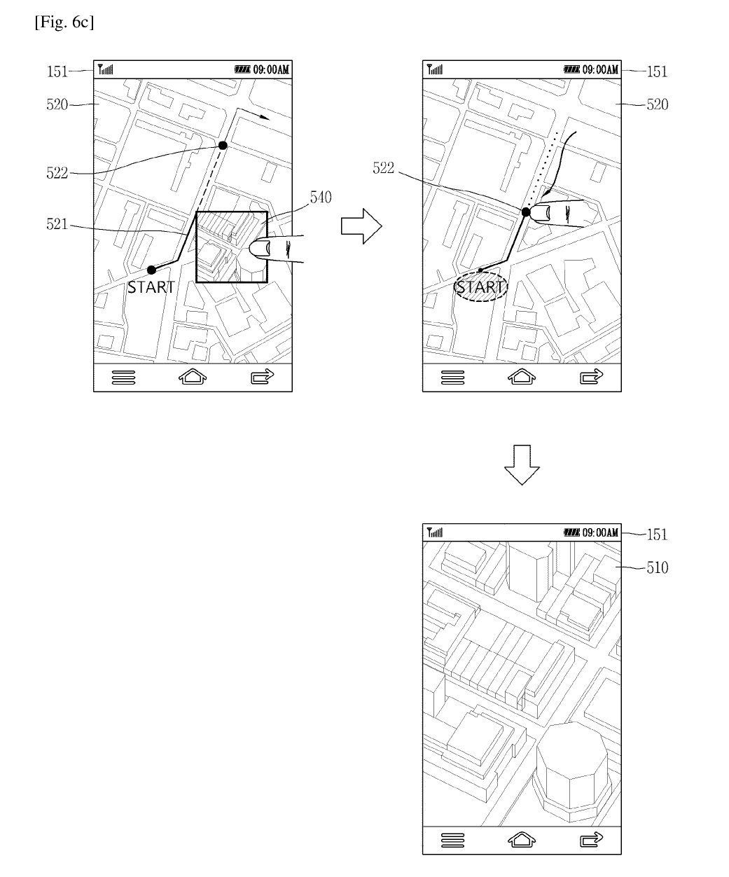

FIGS. 6A and 6B are schematic views illustrating a control method for controlling an output of a thumbnail captured image according to still another embodiment of the present invention.

Referring to FIG. 6A, the display unit 151 may output a thumbnail captured image 540 and a first control icon 541 to one region of the map screen 520. The controller 180 may output the route image 521 based on a touch applied to the first control icon 541.

When the route image 521 is overlapped with the thumbnail captured image 540, that is, when one region of the route image 521 is substantially the same as one region of the thumbnail captured image 540, the controller 180 may control the display unit 151 to enhance transparency of the capturing mage 540. When the transparency of the captured image 540 is increased, the route image 521 may be displayed through the thumbnail captured image 540.

Otherwise, when the route image 521 and the thumbnail captured image 540 are overlapped with each other, the controller 180 may control the display unit 151 to change an output region of the thumbnail captured image 540.

Referring to FIG. 6B, a control method to control the unmanned aircraft 10 based on a touch applied to the map screen, will be described.

The display unit 151 may output the map screen 520 including the route image 521. The display unit 151 may output the captured image 540 to the map screen 520. The display unit 151 may output the first indicator 522 indicating a current position of the unmanned aircraft 10.

The controller 180 may generate a control command for controlling flight of the unmanned aircraft 10 based on a touch applied to the route image 521. Specifically, the controller 180 may detect position information corresponding to a touch point where a touch is applied to the route image 521. The controller 180 may generate a control command related to movement based on the position information, and transmit the control command to the unmanned aircraft 10.

The unmanned aircraft 10 may move to a position corresponding to the position information based on the control command. The display unit 151 may move the first indicator 522 to another region so as to correspond to the position of the unmanned aircraft 10. According to the embodiment of the present invention, it is possible to generate a control command for controlling movement of the unmanned aircraft 10 by using the route image 521.

Further, the display unit 151 may change the output position of the first indicator 522 so as to correspond to the position of the unmanned aircraft 10 based on movement of the unmanned aircraft 10. The display unit 151 may output an additional route image indicating a flight route of the unmanned aircraft 10 based on the control command. The controller 180 may generate a control command for enabling the unmanned aircraft 10 to return via its past flight route or to most quickly arrive at a selected position, based on the touch input. In this instance, the display unit 151 may output a captured image received from the unmanned aircraft 10 as the thumbnail captured image 540.

According to the embodiment of the present invention, a user may generate a control command for controlling flight of the unmanned aircraft using the map screen.

Referring to FIG. 6C, the display unit 151 may output an image 530 to the map screen 520 including the route image 521. The image 530 may be outputted to a region corresponding to position information when the captured image is converted into the map screen, but not to limited thereto.

The controller 180 may detect position information of the unmanned aircraft 10 at the time when the thumbnail captured image 540 has been acquired, based on a touch applied to the thumbnail captured image 540. The controller 180 may generate a control command based on the position information, and transmit the control command to the unmanned aircraft 10. The unmanned aircraft 10 moves to a position where the touch is applied based on the control command.

The display unit 151 may output an additional route image indicating a flight route of the unmanned aircraft 10, and a first indicator 522 corresponding to the position of the unmanned aircraft 10.

When a distance between the unmanned aircraft 10 and the terminal body of the mobile terminal 100 is smaller than or the same as the reference distance (refer to FIG. 2A) as the unmanned aircraft 10 moves, or when the intensity of a wireless signal transceived with the unmanned aircraft 10 is larger than the reference intensity (refer to FIG. 3A), the controller 180 may receive the captured image. The control unit 180 may output the received captured image 510 to the display unit 151.

In the drawing, there is shown that the captured image 510 is outputted instead of the map screen 520, but not limited thereto. For instance, both the map screen 520 and the captured image 510 may be outputted together.

According to the embodiment of the present invention, a user can generate a control command for controlling flight of the unmanned aircraft 10 by using the map screen, and when the captured image is received again, the received captured image may be outputted to the display unit 151 so that the user can be informed that the unmanned aircraft 10 becomes close to the mobile terminal 100.

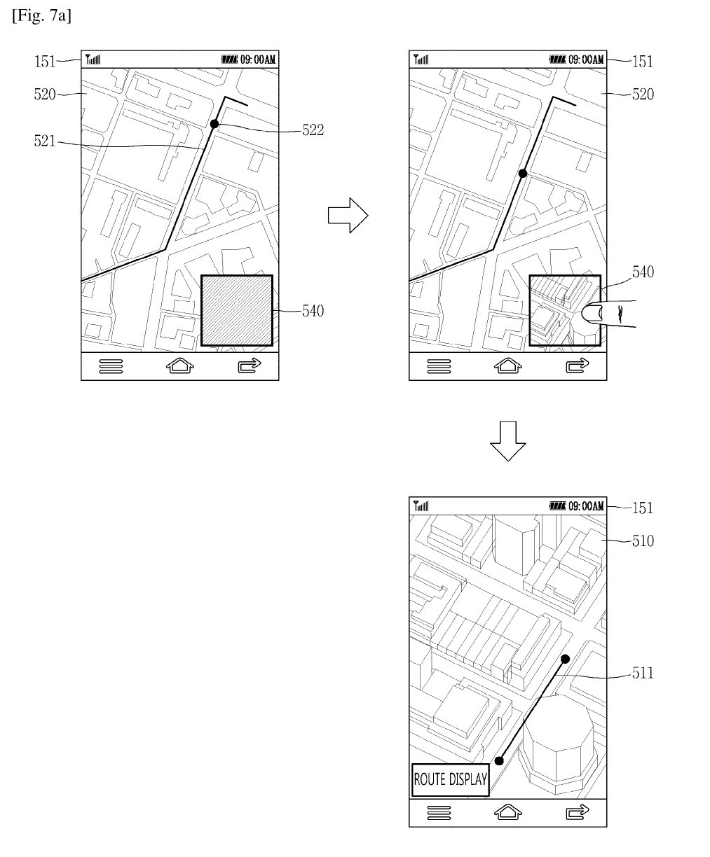

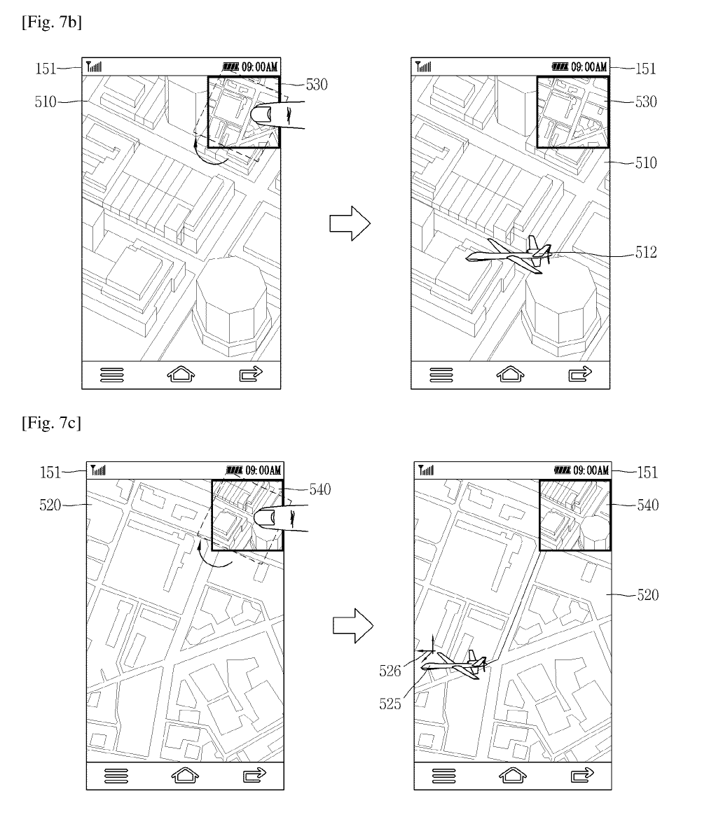

FIGS. 7A through 7C are schematic views illustrating a control method for outputting flight information of the unmanned aircraft.

Referring to FIG. 7A, the display unit 151 may output the map screen 520 including the route image 521. The display unit 151 may output the thumbnail captured image 540 corresponding to the captured image to one region of the map screen 520. However, when the captured image is not received from the unmanned aircraft 10, the display unit 151 may output a specific image as the thumbnail captured image 540. The specific image may have a preset color and correspond to an image of a high transparency.

The controller 180 may control the display unit 151 to move the first indicator 522 based on movement of the unmanned aircraft 10. When the captured image is received from the unmanned aircraft 10, the controller 180 may display the received captured image on the thumbnail captured image 540. The captured image may not be partially received, and the display unit 151 displays the image reflecting the fact that the captured image has not been partially received.

The controller 180 may output the captured image 510 to the display unit 151 based on a touch applied to the thumbnail captured image 540.

Meanwhile, the controller 180 may control the display unit 151 to output a route image 511 in an overlapping manner with the captured image 510. The route image 511 may correspond to a flight route of the unmanned aircraft 10.

According to the embodiment of the present invention, a user can grasp a position of the unmanned aircraft and a wireless communication state based on the image, and when the captured image is stably displayed on the image, the captured image can be provided on the entire screen. Further, since a flight route is displayed on the captured image, a user can grasp a flight route while being provided with the captured image.

Referring to FIG. 7B, the map image 530 is outputted to the captured image 510. The controller 180 may control the display unit 151 to output a direction image 512 to the captured image 510 based on a specific type of touch applied to the map image 530. Here, the specific type of touch may correspond to a consecutive touch applied to the map image 530 along one direction, but is not limited thereto.

The direction image 512 indicates a current flight direction of the unmanned aircraft 10. The flight direction is formed based on the captured image 510.

Meanwhile, referring to FIG. 7C, the thumbnail captured image 540 is displayed on the map screen 520, and the direction image 525 is outputted based on a specific type of touch applied to the thumbnail captured image 540. The direction image 525 may be displayed on the map screen 510, and a graphic image 526 indicating a direction may be further outputted.

According to the embodiments of the present invention, it is possible to display a current flight direction of the unmanned aircraft 10 by applying a touch to the map image or the captured image which are provided in the form of thumbnail view. Though not shown specifically, the display unit 151 may be controlled so that the direction image may disappear when an additional touch is applied to the map image or the thumbnail captured image.

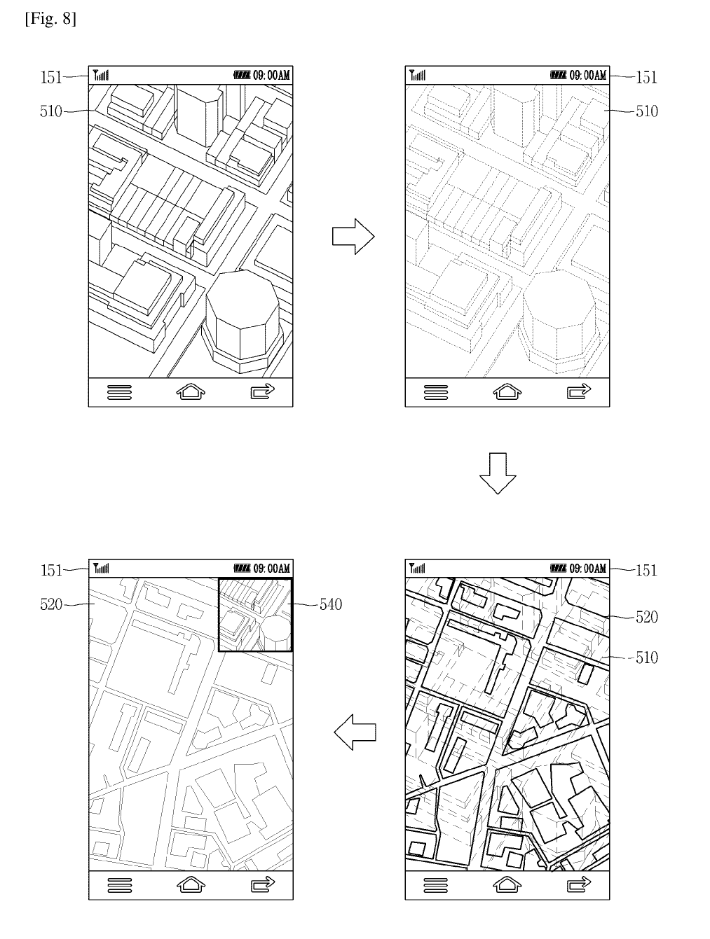

FIG. 8 is a schematic view illustrating a control method for converting a captured image into a map screen according to still another embodiment of the present invention.

The display unit 151 may output a received captured image, and display the captured image in a blurred manner based on a quality of a wireless signal of the wireless communication. Alternatively, when the original of the captured image is received in a blurred state or partially received, it may be displayed on the display unit 151 as it is.

The controller 180 may control the display unit 151 to convert the captured image 510 into the map screen 520. However, in this instance, the map screen 520 may be seen through the captured image 510, and become gradually clearer from a semi-transparent state.

When the received captured image satisfies a specific condition, the controller 180 may output the map screen 520 to the display unit 151 instead of the captured image. Further, the controller 180 may control the display unit 151 to output the thumbnail captured image 540 including the captured image to the map screen 520.

According to the embodiment of the present invention, a communication state of the unmanned aircraft, and a distance between mobile terminal and the unmanned aircraft may be displayed based on the output quality of the captured image, and the captured image may be naturally converted into a map screen based on a change of its transparency.

As described above, the present invention is capable of implementing a computer readable code in a media in which programs are recorded. The computer readable media include all kinds of recording devices in which data readable by a computer system are stored. Examples of the computer readable media are a Hard Disk Drive (HDD), a Solid State Disk (SSD), a Silicon Disk Drive (SSD), a ROM, a RAM, a CD-ROM, a magnetic tape, a floppy disk, an optical data storage device, and include a type in the form of a carrier wave (for instance, transmission via internet). Further, the controller 180 of the computer terminal may be included.

### INDUSTRIAL APPLICABILITY

The embodiments of the present invention as described hereinbefore are related to a watch-type terminal, and includes a control method for providing a map screen which enables a position of an unmanned aircraft to be grasped based on a distance between the mobile terminal and the unmanned aircraft, instead of a captured image which is captured real time, when the unmanned aircraft is not sensed within a user's sight. Thus, the present invention may be applicable to various industrial fields.

1. A mobile terminal, comprising:
a terminal body;
a wireless communication unit configured to communicate with an unmanned aircraft and to receive position information of the unmanned aircraft;
a display unit configured to output a captured image received from the unmanned aircraft; and
a controller configured to compare an expected distance between the unmanned aircraft and the terminal body using the position information of the unmanned aircraft,
wherein the controller controls the display unit to output a map screen including position information of the unmanned aircraft when the expected distance is larger than the reference distance.

2. The mobile terminal of claim 1, wherein the display unit is configured to output a thumbnail captured image corresponding to the captured image to one region of the map screen.

3. The mobile terminal of claim 2, wherein the controller is configured to convert the map screen into the captured image based on a touch applied to the thumbnail captured image.

4. The mobile terminal of claim 2, wherein the map screen includes a route image indicating a flight route of the unmanned aircraft, and a first indicator indicating a position of the unmanned aircraft.

5. The mobile terminal of claim 4, wherein the route image includes a first region indicating a flight route while the captured image is outputted to the display unit, and a second region indicating a flight route while the map screen is outputted to the display unit.

6. The mobile terminal of claim 4, wherein the map screen further includes a second indicator indicating a position of the terminal body.

7. The mobile terminal of claim 4, wherein the controller is configured to control the display unit to convert a map image into the thumbnail captured image while converting the captured image into the map screen when the map image corresponding to the map screen is outputted to one region of the captured image, and
wherein the thumbnail captured image is displayed on one region of the map screen that is not overlapped with the route image.

8. The mobile terminal of claim 2, wherein the display unit is configured to change an output position of the thumbnail captured image or a size of the thumbnail captured image based on a touch applied to the thumbnail captured image.

9. The mobile terminal of claim 2, wherein the display unit is configured to output a direction image based on flight information of the unmanned aircraft when a touch is applied to the thumbnail captured image.

10. The mobile terminal of claim 4, wherein the display unit is configured to output a thumbnail captured image corresponding to a captured image which is received from the unmanned aircraft at the time point when the captured image is converted into the map screen, and
wherein the thumbnail captured image is outputted to a region adjacent to the route image.

11. The mobile terminal of claim 10, wherein when a touch is applied to the route image, the controller is configured to detect position information corresponding to one region of the route image where the touch is applied, and extract a captured image corresponding to the position information, and
wherein the display unit is configured to output a thumbnail captured image corresponding to the captured image together with the route image.

12. The mobile terminal of claim 11, wherein when there is not a captured image corresponding to the position information, the controller is configured to control the display unit to output an image related to the position information and received from a specific server, as the thumbnail captured image.

13. The mobile terminal of claim 1, wherein the controller is configured to detect an intensity of a wireless signal transceiver with the unmanned aircraft, and when the detected signal intensity is smaller than a reference signal intensity, to control the display unit to convert the captured image into the map screen.

14. A method for controlling a mobile terminal, comprising:
wirelessly communicating with an unmanned aircraft which is flying;
receiving position information of the unmanned aircraft;
outputting a captured image received from the unmanned aircraft to a display unit;
comparing an expected distance between the unmanned aircraft and a terminal body with a reference distance, using position information of the unmanned aircraft; and
outputting a map screen including position information of the unmanned aircraft when the expected distance is larger than the reference distance.

15. The method of claim 14, further comprising:
detecting an intensity of a wireless signal transmitted from a wireless communication unit;
comparing the detected intensity of the wireless signal with an intensity of a reference signal; and
converting the captured image into the map screen when the detected intensity of the wireless signal is smaller than the intensity of the reference signal.
